(19) United States
(12) Patent Application Publication
(10) Pub. No.: US 2026/0051087 A1
(43) Pub. Date: Feb. 19, 2026

(54) TEXT-TO-MASK AND MASK-TO-IMAGE SYNTHESIS

(71) Applicant: ADOBE INC., SAN JOSE, CA (US)

(72) Inventors: Jason Wen Yong Kuen, San Jose, CA (US); Hanrong Ye, HKUST (HK); Qing Liu, Santa Clara, CA (US); Zhe Lin, Clyde Hill, WA (US); Brian Lynn Price, Pleasant Grove, UT (US)

(21) Appl. No.: 18/804,412

(22) Filed: Aug. 14, 2024

(51) Int. Cl. G06T 11/00; G06F 40/40; G06T 7/11

(52) U.S. Cl. CPC G06T 11/001; G06F 40/40; G06T 7/11; G06T 2207/10024; G06T 2207/20081

(57) ABSTRACT

A method, apparatus, non-transitory computer readable medium, and system for data generation include obtaining a text prompt describing an object within a scene and generating, using a text-to-mask generation model and based on the text prompt, a color map corresponding to the scene. The color map indicates a region corresponding to the object from the text prompt. An image segmentation mask is generated based on the color map. The image segmentation mask comprises a plurality of regions corresponding to a plurality of image elements in the scene including the region corresponding to the object from the text prompt.

### BACKGROUND

The following relates generally to image processing, and more specifically to image segmentation and image generation. Machine learning models may be used for both image segmentation and image generation. Image segmentation is an image processing task that partitions an image into segments based on the content of the image. Image segmentation tasks include semantic segmentation and instance segmentation. Semantic segmentation refers to the assignment of categories (e.g., vehicle, animal, etc.) to each pixel in an image. Instance segmentation refines semantic segmentation by differentiating between instances of each category. Image generation refers to the task of generating synthetic image data. In some cases, the image data is generated using guidance such as a text description of the output or control guidance such as layout information.

### SUMMARY

The present disclosure describes systems and methods for synthetic data generation. Embodiments of the present disclosure include a data generation apparatus configured to generate a synthetic dataset based on text prompts using a combination of a text-to-mask generation model and a mask-to-image generation model. The synthetic dataset includes pairs of image segmentation masks and synthesized images which can be used for training segmentation models. In some examples, an image segmentation mask is input to the mask-to-image generation model, which generates a synthesized image based on a text prompt and the image segmentation mask. Alternatively, a human-annotated segmentation mask is input to the mask-to-image generation model to generate a synthesized image based on the text prompt. The image segmentation mask and the synthesized image form a synthetic training pair for image segmentation. In some examples, the synthetic dataset includes image segmentation masks and corresponding synthesized images.

A method, apparatus, and non-transitory computer readable medium for synthetic data generation are described. One or more embodiments of the method, apparatus, and non-transitory computer readable medium include obtaining a text prompt describing an object within a scene; generating, using a text-to-mask generation model and based on the text prompt, a color map corresponding to the scene, wherein the color map indicates a region corresponding to the object from the text prompt; and generating an image segmentation mask based on the color map, wherein the image segmentation mask comprises a plurality of regions corresponding to a plurality of image elements in the scene including the region corresponding to the object from the text prompt.

A method, apparatus, and non-transitory computer readable medium for synthetic data generation are described. One or more embodiments of the method, apparatus, and non-transitory computer readable medium include obtaining a training set including a text prompt describing a scene and a ground-truth color map indicating a location of an object in the scene and training, using the training set, a text-to-mask generation model to generate an image segmentation mask based on the text prompt.

An apparatus and method for synthetic data generation are described. One or more embodiments of the apparatus and method include at least one processor; at least one memory including instructions executable by the at least one processor; and a text-to-mask generation model comprising parameters stored in the at least one memory and trained to generate a color map based on a text prompt, wherein the color map indicates a location of an object from the text prompt.

### BRIEF DESCRIPTION OF THE DRAWINGS

FIG. 1 shows an example of a data generation system according to aspects of the present disclosure.

FIG. 2 shows an example of synthetic data generation according to aspects of the present disclosure.

FIG. 3 shows an example of image segmentation masks according to aspects of the present disclosure.

FIG. 4 shows an example of synthesized images according to aspects of the present disclosure.

FIGS. 5 and 6 show examples of comparison between real images and synthesized images according to aspects of the present disclosure.

FIGS. 7 and 8 show examples of training a segmentation model using synthetic data according to aspects of the present disclosure.

FIG. 9 shows an example of a method for synthetic data generation according to aspects of the present disclosure.

FIG. 10 shows an example of a data generation apparatus according to aspects of the present disclosure.

FIGS. 11 and 12 show examples of a machine learning model according to aspects of the present disclosure.

FIG. 13 shows an example of a text-to-mask generation model according to aspects of the present disclosure.

FIG. 14 shows an example of a mask-to-image generation model according to aspects of the present disclosure.

FIG. 15 shows an example of an image generation model according to aspects of the present disclosure.

FIG. 16 shows an example of a guided latent diffusion model according to aspects of the present disclosure.

FIG. 17 shows an example of an image generation model comprising a control network according to aspects of the present disclosure.

FIG. 18 shows an example of a control network of an image generation model according to aspects of the present disclosure.

FIG. 19 shows an example of a method for creating a training set according to aspects of the present disclosure.

FIG. 20 shows an example of a method for training a text-to-mask generation model according to aspects of the present disclosure.

FIG. 21 shows an example of a method for training a mask-to-image generation model according to aspects of the present disclosure.

FIG. 22 shows an example of a computing device for data generation according to aspects of the present disclosure.

### DETAILED DESCRIPTION

The present disclosure describes systems and methods for synthetic data generation, including image generation and segmentation map generation. Embodiments of the present disclosure include a computing apparatus configured to generate a synthetic dataset based on text prompts using a combination of a text-to-mask generation model and a mask-to-image generation model. The synthetic dataset can include image segmentation masks and synthesized images which can be used for training segmentation models.

In some examples, an image segmentation mask is input to the mask-to-image generation model, which generates a synthesized image based on a text prompt and the image segmentation mask. Alternatively, a human-annotated segmentation mask is input to the mask-to-image generation model to generate a synthesized image based on the text prompt. The image segmentation mask and the synthesized image form a synthetic training pair for image segmentation. In some examples, the synthetic dataset includes image segmentation masks, synthesized images, or both (e.g., synthetic training pairs).

Image processing systems can perform classification, object localization, semantic segmentation, and instance-level segmentation. For example, semantic segmentation relates to pixel-level understanding of object categories. Instance segmentation involves instance grouping of pixels while panoptic segmentation considers both. Obtaining high-quality annotation can be difficult because every individual pixel requires human labeling. Image segmentation models require high-quality segmentation masks and a large-scale dataset for training and enhancement. However, human-annotated segmentation dataset is expensive to obtain and limited in size.

Embodiments of the present disclosure include a data generation apparatus configured to obtain a text prompt and generates, using a text-to-mask generation model, an image segmentation mask based on the input prompt. In some examples, the text-to-mask generation model includes a diffusion model fine-tuned on [text, segmentation color map] training pairs. The trained text-to-mask generation model takes a text prompt as input and generates an image segmentation mask. The text prompt is converted to a color map, which is then projected to obtain the image segmentation mask. The image segmentation mask and the text prompt are then fed to a mask-to-image generation model to generate a synthesized image. The mask-to-image generation model is trained or fine-tuned on [text, segmentation color map, image] training triplets.

In some cases, the mask-to-image generation model receives real segmentation masks as input (i.e., human-annotated segmentation masks). Pairs of image segmentation masks and corresponding synthesized images can be used to train image segmentation models. A synthetic training pair for image segmentation includes an image segmentation mask and a corresponding synthesized image.

One or more embodiments provide synthetic data generation for generating high-quality segmentation training dataset. A first data generation model, i.e., the text-to-mask generation model, is configured to generate synthesized (new) segmentation masks based on text prompts. Then, a second data generation model, i.e., the mask-to-image generation model, is configured to generate synthesized (new) images that align well with the image segmentation masks. In some examples, the mask-to-image generation model receives human-annotated segmentation masks as input (as opposed to image segmentation masks) and generates synthesized images.

The present disclosure describes systems and methods that improve the accuracy of generative machine learning models. For example, some embodiments improve object segmentation accuracy, including generating diverse and high-quality synthetic training samples that cover object classes not seen in existing datasets. Improved accuracy is achieved using a combination of a text-to-mask generation model and the mask-to-image generation model. Image segmentation masks and synthesized images generated by the two generative models improve the diversity and sufficiency of training samples for image segmentation tasks.

In some cases, these synthetic dataset (e.g., pairs of image segmentation masks and synthesized images) can be used to train segmentation models. Furthermore, the synthesized images align better with human-labeled segmentation masks. With an increased number of high-quality synthetic training samples, the accuracy and performance of the segmentation models can be improved.

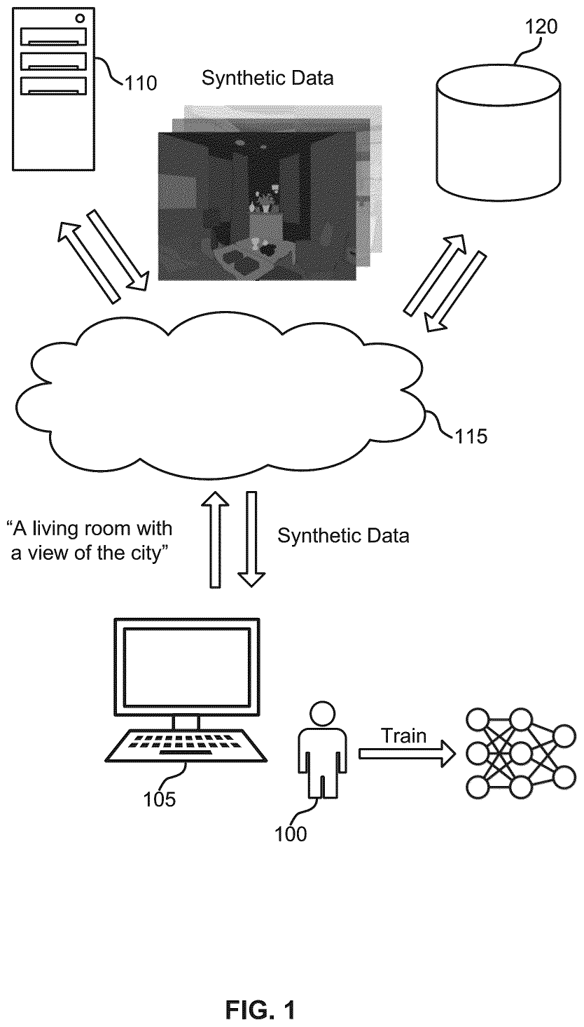

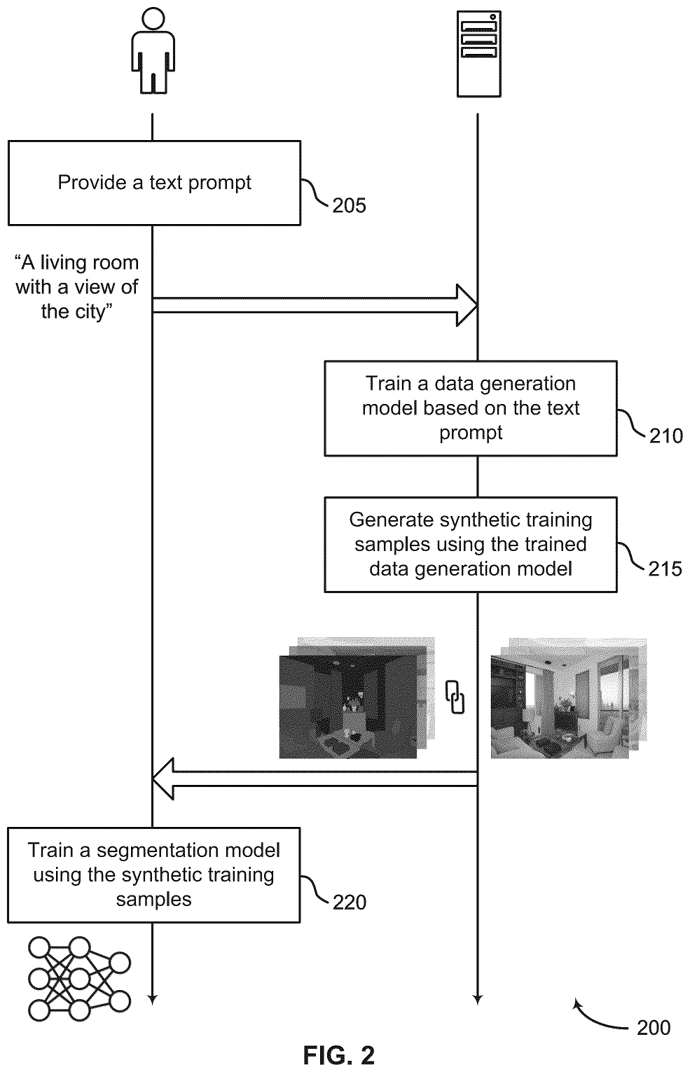

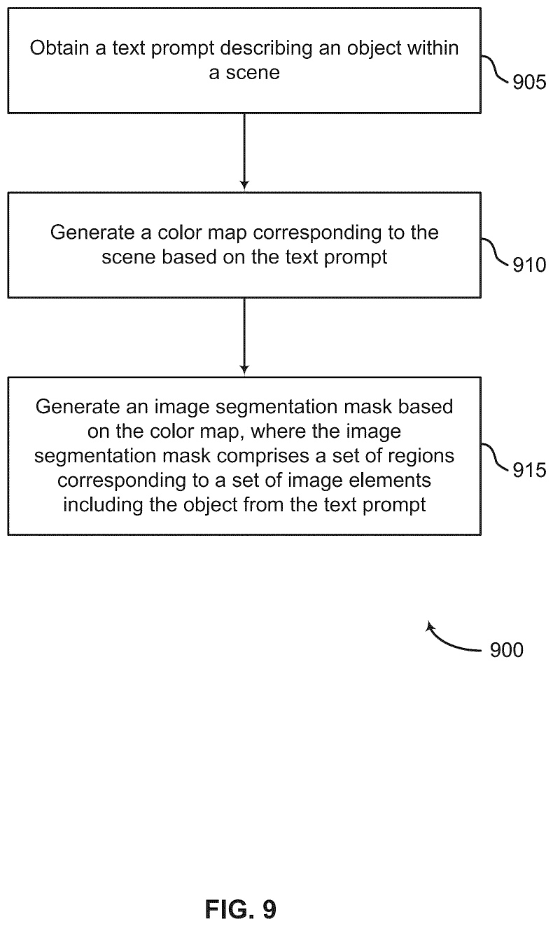

Examples of application in synthetic data generation context are provided with reference to FIGS. 2-8. Details regarding the architecture of an example data generation system are provided with reference to FIGS. 1 and 10-18. Details regarding the data generation process are provided with reference to FIG. 9.

### Synthetic Data Generation

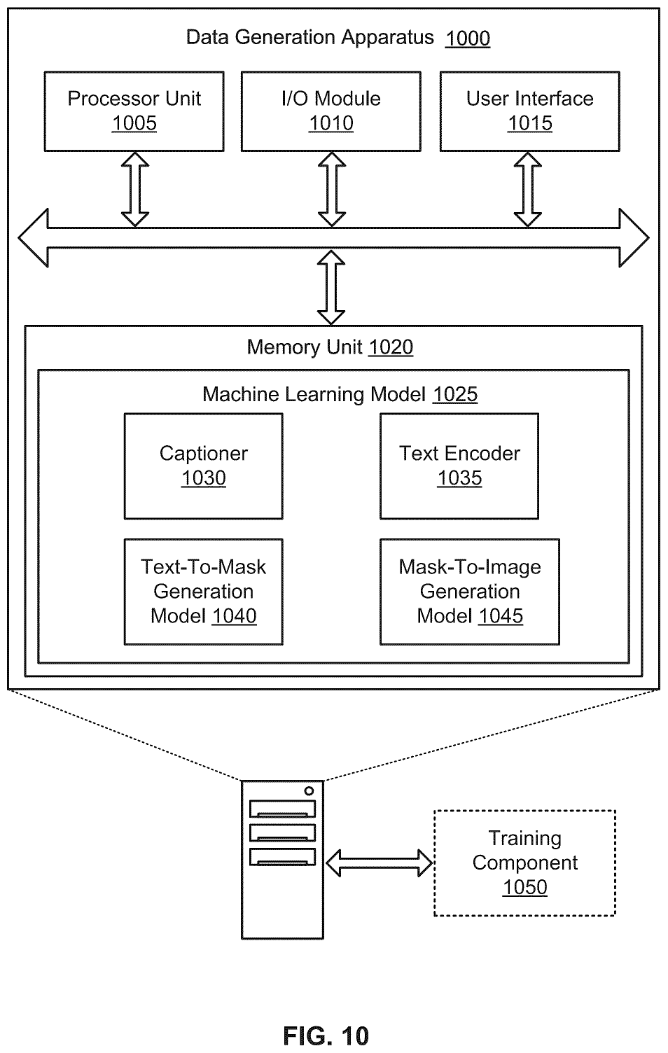

FIG. 1 shows an example of a data generation system according to aspects of the present disclosure. The example shown includes user 100, user device 105, data generation apparatus 110, cloud 115, and database 120. Data generation apparatus 110 is an example of, or includes aspects of, the corresponding element described with reference to FIG. 10.

In an example shown in FIG. 1, an input prompt is provided by user 100 and transmitted to data generation apparatus 110, e.g., via user device 105 and cloud 115. For example, the input prompt is “A living room with a view of the city”. The input prompt describes one or more objects (“living room”, “view”, “city”). Data generation apparatus 110 generates synthetic training samples for downstream applications such as image segmentation. The synthetic training samples can be used to train image segmentation models.

In some embodiments, data generation apparatus 110 takes the text prompt as input and generates, using a text-to-mask generation model, a color map that indicates an image region occupied by the object with a color corresponding to the object. Data generation apparatus 110 generates an image segmentation mask for the object based on the color map. In some cases, data generation apparatus 110 generates, using a mask-to-image generation model, a synthesized image based on the text prompt and the image segmentation mask. The synthetic training samples include the image segmentation mask and synthesized image. Data generation apparatus 110 returns the synthetic data to user 100 via cloud 115 and user device 105. User 100 trains or fine-tunes a segmentation model using the synthetic data.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator). In some examples, the image processing application on user device 105 may include functions of data generation apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Data generation apparatus 110 includes a computer implemented network comprising a captioner, text encoder, a text-to-mask generation model, and a mask-to-image generation model. Data generation apparatus 110 may also include a processor unit, a memory unit, an I/O module, a user interface, and a training component. The training component is used to train a machine learning model comprising the text-to-mask generation model and the mask-to-image generation model. Additionally, data generation apparatus 110 can communicate with database 120 via cloud 115. In some cases, the architecture of the image generation network is also referred to as a network, a machine learning model, or a network model. Further detail regarding the architecture of data generation apparatus 110 is provided with reference to FIGS. 10-18. Further detail regarding the operation of data generation apparatus 110 is provided with reference to FIGS. 2 and 9.

In some cases, data generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., candidate text style images, candidate text content images, a training set including one or more ground-truth images) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for synthetic data generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the user provides a text prompt. In some cases, the operations of this step refer to, or may be performed by, a user as described with reference to FIG. 1. For example, the text prompt is “A living room with a view of the city”.

At operation 210, the system trains a data generation model based on the text prompt. In some cases, the operations of this step refer to, or may be performed by, a data generation apparatus as described with reference to FIGS. 1 and 10. In some examples, the data generation model is configured to synthesize training samples for improving the performance of segmentation models. At training time, the data generation model is trained with human-annotated training samples from public datasets.

At operation 215, the system generates synthetic training samples using the trained data generation model. In some cases, the operations of this step refer to, or may be performed by, a data generation apparatus as described with reference to FIGS. 1 and 10.

After training, the data generation model generates synthetic segmentation training samples at scale (i.e., new samples). In some examples, the synthetic training samples include synthetic segmentation masks, synthetic images, or combination thereof (e.g., pairs of synthetic segmentation masks and synthetic images). The generated training samples are incorporated into the training process of down-stream segmentation models to increase model performance.

At operation 220, the user trains a segmentation model using the synthetic training samples. In some cases, the operations of this step refer to, or may be performed by, a user as described with reference to FIG. 1. The synthetic training data is used to train segmentation models. In some cases, synthetic training dataset produced by the data generation model and existing dataset (e.g., human-annotated masks) are jointly used to train segmentation models.

In some examples, the synthetic dataset is used for random data augmentation. In every iteration of the training process, each real training sample is replaced by a synthetic training sample with a probability p_{aug}. This process is also referred to as synthetic data augmentation. In some cases, a synthetic data pre-training method involves a pre-training stage and a fine-tuning stage. The pre-training stage involves pre-training a segmentation model on the synthetic dataset, so that the segmentation model learns good weights that are transferable and favorable for fine-tuning. At fine-tuning stage, the segmentation model is trained with human-annotated data.

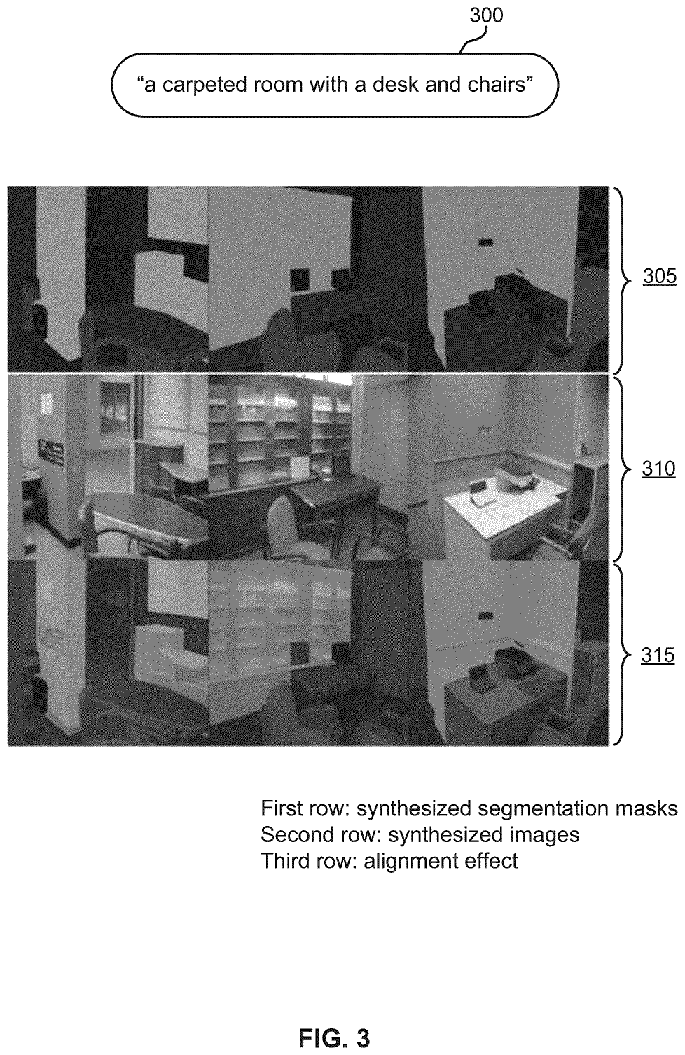

FIG. 3 shows an example of image segmentation masks 305 according to aspects of the present disclosure. The example shown includes text prompt 300, image segmentation masks 305, synthesized images 310, and alignment effect 315. For example, a first row includes image segmentation masks 305. A second row includes synthesized images 310. A third row includes alignment effect 315.

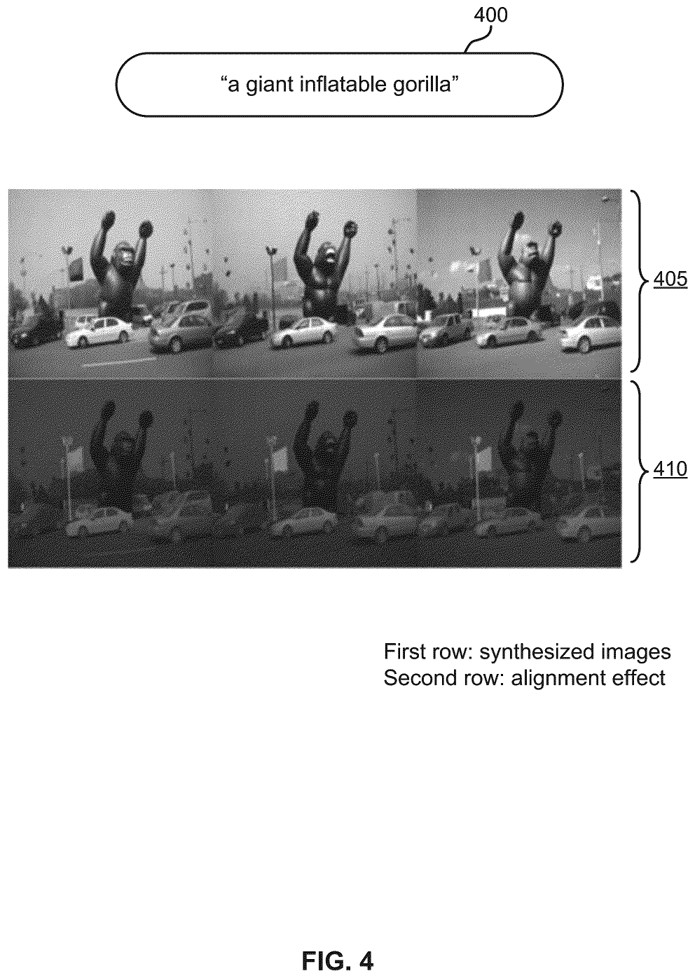

Text prompt 300 is “a carpeted room with a desk and chairs”. Text prompt 300 is an example of, or includes aspects of, the corresponding element described with reference to FIGS. 4, and 13-15.

FIG. 3 shows generated samples based on dataset ADE20K. The third row overlays a mask of image segmentation masks 305 and a corresponding synthesized image of synthesized images 310 together to demonstrate alignment effect 315 between them. The image segmentation masks 305 and synthesized images 310 show high perceptual quality and excellent alignment.

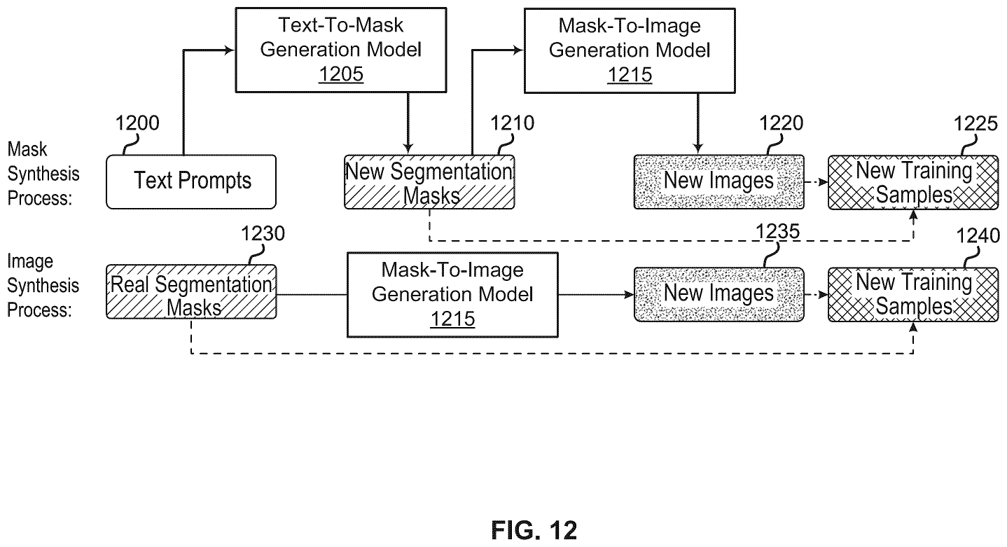

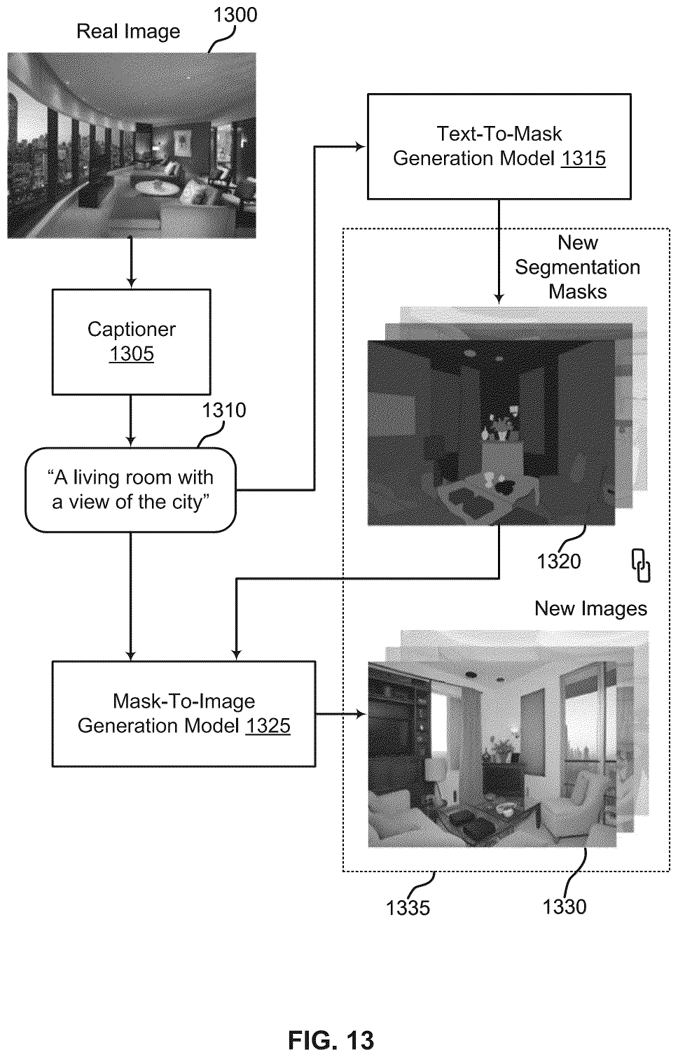

Image segmentation masks 305 are an example of, or include aspects of, the corresponding element described with reference to FIGS. 12 and 13. Synthesized images 310 is an example of, or includes aspects of, the corresponding element described with reference to FIGS. 4, 5, and 12-14. Alignment effect 315 is an example of, or includes aspects of, the corresponding element described with reference to FIG. 4.

FIG. 4 shows an example of synthesized images 405 according to aspects of the present disclosure. The example shown includes text prompt 400, synthesized images 405, and alignment effect 410. For example, the first row includes synthesized images 405. The second row includes alignment effect 410.

FIG. 4 shows generated samples. The synthesized images 405 show remarkable realism and they align well with human-labeled segmentation masks and text prompts. Text prompt 400 is “a giant inflatable gorilla”. Text prompt 400 is an example of, or includes aspects of, the corresponding element described with reference to FIGS. 3, and 13-15.

Synthesized images 405 is an example of, or includes aspects of, the corresponding element described with reference to FIGS. 3, 5, and 12-14. Alignment effect 410 is an example of, or includes aspects of, the corresponding element described with reference to FIG. 3.

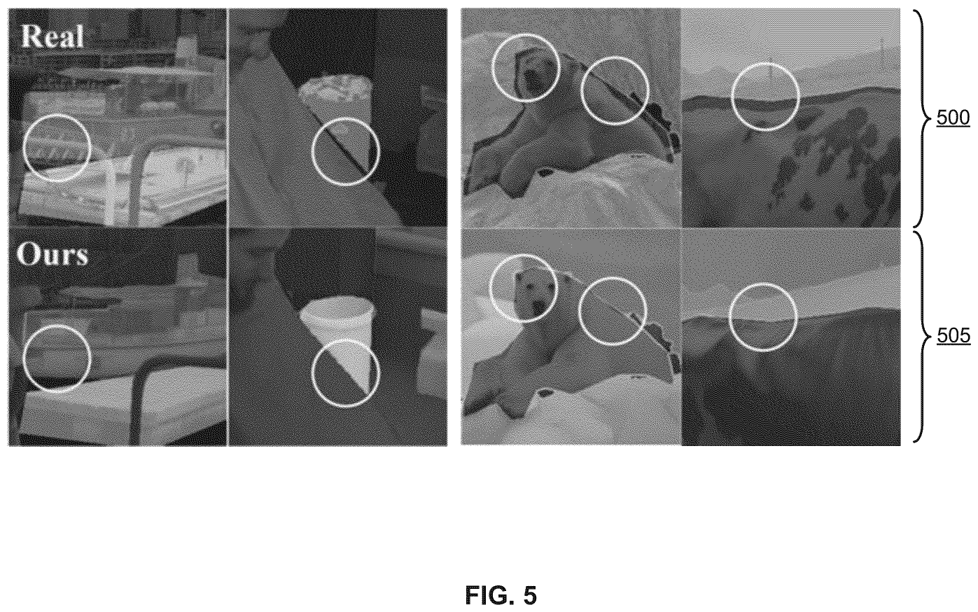

FIG. 5 shows an example of comparison between real images 500 and synthesized images 505 according to aspects of the present disclosure. The example shown includes real images 500 and synthesized images 505. Synthesized images 505 are an example of, or include aspects of, the corresponding element described with reference to FIGS. 3, 4, and 12-14.

FIG. 5 shows zoom-in comparison of real images 500 and synthesized images 505 via an image synthesis network. As highlighted in circles, synthesized images 505 align better with human-labeled segmentation masks because of the inaccuracies in human annotations. The left two columns are from dataset (e.g., ADE20K) and the right two columns are from dataset COCO.

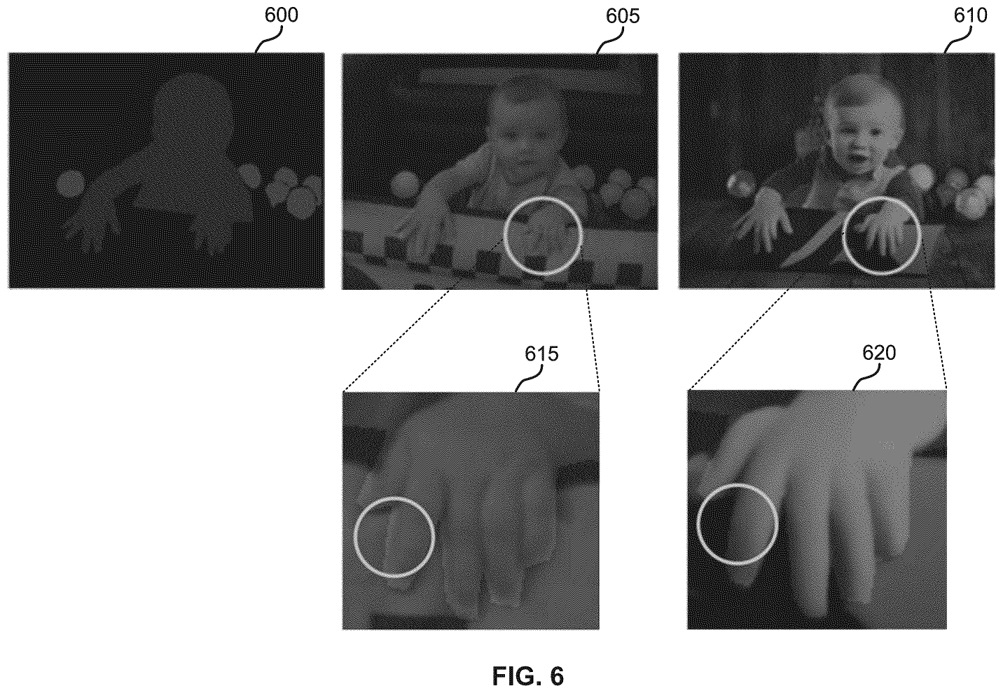

FIG. 6 shows an example of comparison between real images 605 and synthesized images 610 according to aspects of the present disclosure. The example shown includes segmentation mask 600, real image 605, synthesized image 610, zoom-in real image 615, and zoom-in synthesized image 620. Real image 605 is an example of, or includes aspects of, the corresponding element described with reference to FIG. 13.

In some examples, a mask-to-image generation model (with reference to FIG. 10) takes segmentation mask 600 as input and generates synthesized image 610. Synthesized image 610 has improved alignment compared to ground-truth image (i.e., real image 605). Zoom-in real image 615 shows alignment is not desired in certain areas (e.g., fingers). Zoom-in synthesized image 620 shows improved alignment.

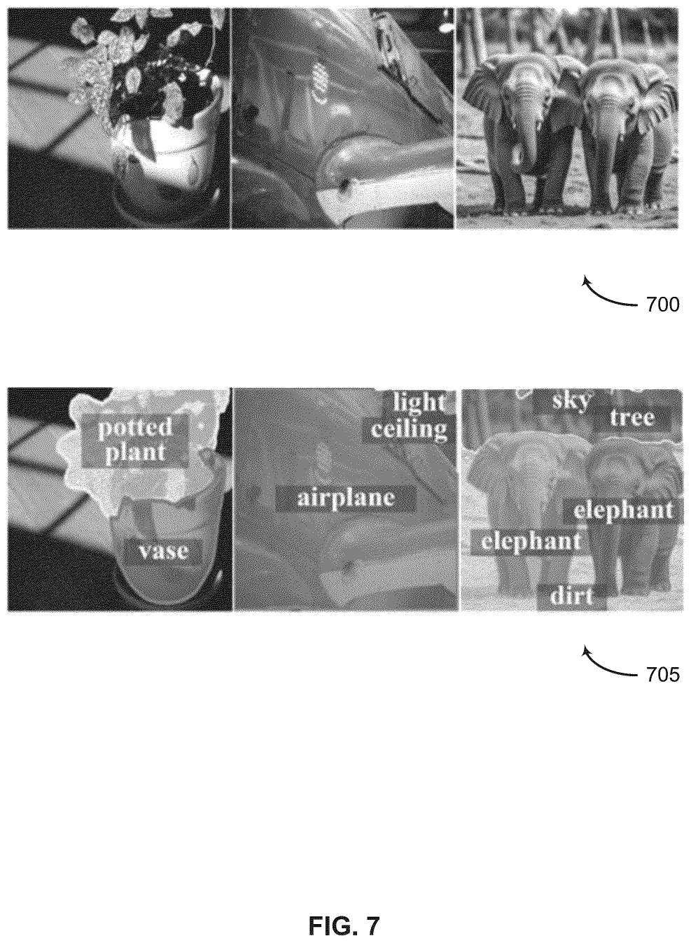

FIG. 7 shows an example of training a segmentation model using synthetic data according to aspects of the present disclosure. The example shown includes unseen domains 700 and segmentation output 705.

In an embodiment, a data generation apparatus (with reference to FIG. 10) generates a synthetic dataset including image segmentation masks and synthesized images. Training with the synthetic dataset can improve the performance of segmentation models such as Mask2Former model on evaluation benchmarks including ADE20K and COCO. Segmentation models trained using the synthetic dataset become robust towards images from unseen domains 700. In some cases, a trained segmentation model generates segmentation output 705 that includes semantic segmentation information and instance segmentation information.

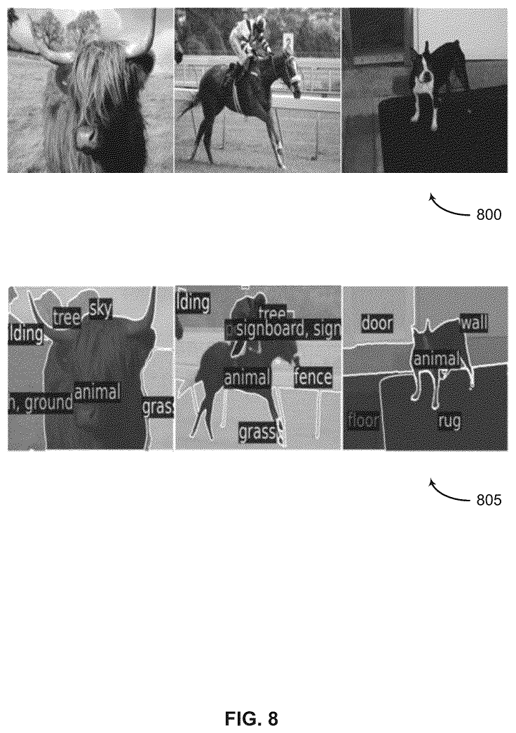

Unseen domains 700 is an example of, or includes aspects of, the corresponding element described with reference to FIG. 8. Segmentation output 705 is an example of, or includes aspects of, the corresponding element described with reference to FIG. 8.

FIG. 8 shows an example of training a segmentation model using synthetic data according to aspects of the present disclosure. The example shown includes unseen domains 800 and segmentation output 805.

In an embodiment, a data generation apparatus (with reference to FIG. 10) generates a synthetic dataset including image segmentation masks and synthesized images. Training with the synthetic dataset can improve the performance of segmentation models (e.g., Mask2Former model). Segmentation models trained using the synthetic dataset become robust towards images from unseen domains 800. In some examples, a baseline segmentation model is trained on dataset ADE20K.

In some examples, training a segmentation model using the synthetic dataset improves segmentation generalization performance. A segmentation model generates segmentation output 805 on unseen domains 800 (e.g., images from PASCAL). Unseen domains 800 is an example of, or includes aspects of, the corresponding element described with reference to FIG. 7. Segmentation output 805 is an example of, or includes aspects of, the corresponding element described with reference to FIG. 7.

FIG. 9 shows an example of a method 900 for synthetic data generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains a text prompt describing an object within a scene. In some cases, the operations of this step refer to, or may be performed by, a text-to-mask generation model as described with reference to FIGS. 10-13. For example, a text prompt is “A living room with a view of the city”. Here, an object is “living room” or “city”.

At operation 910, the system generates, using a text-to-mask generation model, a color map corresponding to the scene based on the text prompt. The color map includes a region corresponding to the object from the text prompt. For example, the color map may include a color corresponding to the location of the object within the scene including one or more objects and background elements. In some cases, the operations of this step refer to, or may be performed by, a text-to-mask generation model as described with reference to FIGS. 10-13.

In an embodiment, the text-to-mask generation model is trained to perform projection from color maps to segmentation masks, e.g., f_{color→mask}. The text-to-mask generation model is configured to project color maps to segmentation masks for semantic segmentation. For each pixel on the color maps, the text-to-mask generation model identifies its nearest color (with Euclidean distance) in a lookup table and assigns the corresponding class to the pixel in the segmentation masks.

In some examples, a color map is a three-channel RGB-like map, where each color represents a category. The color map is an intermediate output generated based on a text prompt using the text-to-mask generation model. The color map is denoted as C_{syn}∈ [symbol] ^{H×W×3}. In some cases, the color map may also be referred to as a synthesized color map. The color mask labels each pixel in an original image according to the object or region it belongs to (e.g., each color represents a different object or region). For example, an original image having different classes like sky, trees, cars, and roads are labeled with different colors.

At operation 915, the system generates an image segmentation mask based on the color map, where the image segmentation mask comprises a set of regions corresponding to a set of image elements of the scene including the object from the text prompt. In some cases, the operations of this step refer to, or may be performed by, a text-to-mask generation model as described with reference to FIGS. 10-13. In some examples, synthetic data for training segmentation models includes pairs of image segmentation masks and synthesized images. The image segmentation mask, generated using a data generation apparatus (with reference to FIG. 10), can be used to train image segmentation models.

In some examples, a segmentation mask represents an image that is being partitioned into different segments. Each segment of the segmentation mask corresponds to a specific object or a region of interest. In some examples, the segmentation mask includes a binary segmentation mask or a multi-class segmentation mask. The segmentation mask labels each pixel in an original image according to the object or region it belongs to. With regard to multi-class segmentation, the segmentation mask contains more than two classes, where each class represents a different object or region. For example, an original image having different classes like sky, trees, cars, and roads are labeled with different colors.

In an embodiment, a mask-to-image generation model generates a synthesized image based on the text prompt and the image segmentation mask. The mask-to-image generation model performs projection from segmentation masks to color maps, e.g., f_{mask→color}. For semantic segmentation, the value of each pixel on the segmentation mask corresponds to a category ID, enabling the mask-to-image generation model to convert the masks directly into an RGB color map using a pre-defined lookup table. For panoptic and instance segmentation, after mapping the category IDs to color maps, the mask-to-image generation model is configured to outline each segment with a special edge color on the color map. This ensures that the mask-to-image generation model recognizes the specific instance it belongs to.

In FIGS. 1-9, a method, apparatus, and non-transitory computer readable medium for synthetic data generation are described. One or more embodiments of the method, apparatus, and non-transitory computer readable medium include obtaining a text prompt describing an object; generating, using a text-to-mask generation model, a color map based on the text prompt, where the color map includes a region corresponding to the object from the text prompt; and generating an image segmentation mask based on the color map, where the image segmentation mask comprises a set of regions corresponding to a set of image elements including the object from the text prompt.

Some examples of the method, apparatus, and non-transitory computer readable medium further include generating, using a mask-to-image generation model, a synthesized image based on the text prompt and the image segmentation mask.

Some examples of the method, apparatus, and non-transitory computer readable medium further include creating a training set including the image segmentation mask and the synthesized image. Some examples further include training a segmentation model using the training set. Some examples of the method, apparatus, and non-transitory computer readable medium further include obtaining an annotated segmentation mask. Some examples further include generating, using a mask-to-image generation model, a synthesized image based on the text prompt and the annotated segmentation mask.

Some examples of the method, apparatus, and non-transitory computer readable medium further include generating a plurality of image segmentation masks based on the color map. Some examples of the method, apparatus, and non-transitory computer readable medium further include encoding the text prompt to obtain text features representing the object, wherein the color map is generated based on the text features. In some examples, the color map includes a plurality of colors corresponding to a plurality of elements of the scene described by the text prompt.

### Network Architecture

FIG. 10 shows an example of a data generation apparatus 1000 according to aspects of the present disclosure. The example shown includes data generation apparatus 1000, processor unit 1005, I/O module 1010, user interface 1015, memory unit 1020, machine learning model 1025, and training component 1050. Data generation apparatus 1000 is an example of, or includes aspects of, the corresponding element described with reference to FIG. 1.

Processor unit 1005 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 1005 is configured to operate a memory array using a memory controller. In other cases, a memory controller is integrated into the processor. In some cases, processor unit 1005 is configured to execute computer-readable instructions stored in a memory to perform various functions. In some embodiments, processor unit 1005 includes special purpose components for modem processing, baseband processing, digital signal processing, or transmission processing.

Examples of memory unit 1020 include random access memory (RAM), read-only memory (ROM), or a hard disk. Examples of memory unit 1020 include solid state memory and a hard disk drive. In some examples, memory unit 1020 is used to store computer-readable, computer-executable software including instructions that, when executed, cause a processor to perform various functions described herein. In some cases, memory unit 1020 contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within memory unit 1020 store information in the form of a logical state.

In some examples, at least one memory unit 1020 includes instructions executable by the at least one processor unit 1005. Memory unit 1020 includes machine learning model 1025 or stores parameters of machine learning model 1025.

I/O module 1010 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 1010 includes a user interface 1015. A user interface 815 may enable a user to interact with a device. In some embodiments, the user interface 1015 may include an audio device, such as an external speaker system, an external display device such as a display screen, or an input device (e.g., remote control device interfaced with the user interface 815 directly or through an I/O controller module). In some cases, a user interface 1015 may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some embodiments of the present disclosure, data generation apparatus 1000 includes a computer implemented artificial neural network (ANN) for text-to-mask generation and mask-to-image generation. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

Accordingly, during the training process, the parameters and weights of the data generation apparatus 1000 are adjusted to increase the accuracy of the result (i.e., by attempting to minimize a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some embodiments, data generation apparatus 1000 includes a convolutional neural network (CNN) for text-to-mask generation and mask-to-image generation. CNN is a class of neural networks that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

In one embodiment, machine learning model 1025 includes captioner 1030, text encoder 1035, text-to-mask generation model 1040, and mask-to-image generation model 1045.

According to some embodiments, captioner 1030 obtains an image corresponding to a ground-truth color map. In some examples, captioner 1030 generates a text prompt based on the image. In some examples, captioner 1030 is configured to generate an image description based on the image. Captioner 1030 is an example of, or includes aspects of, the corresponding element described with reference to FIG. 13.

According to some embodiments, text encoder 1035 encodes the text prompt to obtain text features representing an object, where the color map is generated based on the text features.

According to some embodiments, text-to-mask generation model 1040 obtains a text prompt describing an object within a scene. In some examples, text-to-mask generation model 1040 generates a color map that indicates an image region occupied by the object with a color corresponding to the object. Text-to-mask generation model 1040 generates an image segmentation mask for the object based on the color map. In some examples, text-to-mask generation model 1040 generates a set of image segmentation masks based on the color map. In some examples, the color map includes a set of colors corresponding to a set of elements of the scene described by the text prompt.

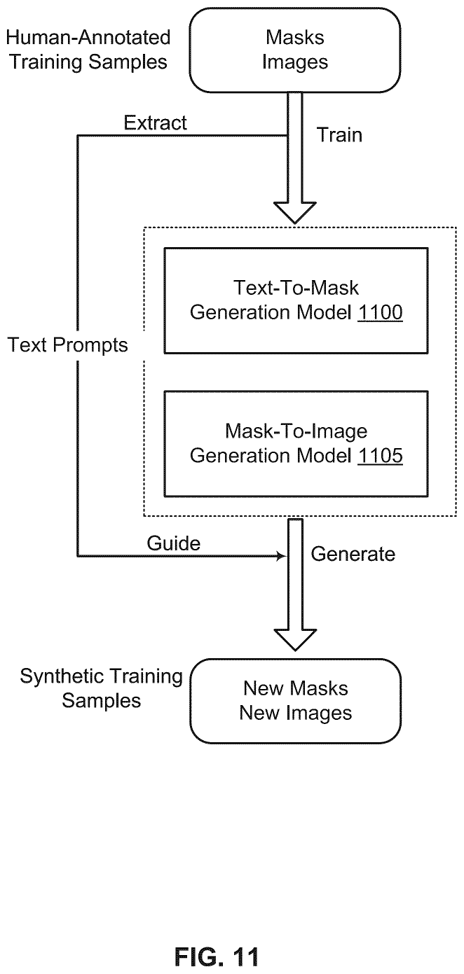

According to some embodiments, text-to-mask generation model 1040 (comprising parameters stored in the at least one memory such as memory unit 1020) is trained to generate a color map that indicates an image region occupied by an object described by a text prompt with a color corresponding to the object. In some examples, the text-to-mask generation model 1040 is configured to generate an image segmentation mask for the object based on the color map. In some examples, the text-to-mask generation model 1040 includes a diffusion model. Text-to-mask generation model 1040 is an example of, or includes aspects of, the corresponding element described with reference to FIGS. 11-13.

According to some embodiments, mask-to-image generation model 1045 generates a synthesized image based on the text prompt and the image segmentation mask. In some examples, mask-to-image generation model 1045 obtains an annotated segmentation mask. Mask-to-image generation model 1045 generates a synthesized image based on the text prompt and the annotated segmentation mask.

According to some embodiments, mask-to-image generation model 1045 is trained to generate a synthesized image based on the text prompt and an image segmentation mask. In some examples, the mask-to-image generation model 1045 includes a diffusion model. Mask-to-image generation model 1045 is an example of, or includes aspects of, the corresponding element described with reference to FIGS. 11-14.

According to some embodiments, training component 1050 creates a training set including the image segmentation mask and the synthesized image. In some examples, training component 1050 trains a segmentation model using the training set.

According to some embodiments, training component 1050 obtains a training set including a text prompt describing a scene and a ground-truth color map indicating a location of an object in the scene. In some examples, training component 1050 trains, using the training set, a text-to-mask generation model 1040 to generate an image segmentation mask based on the text prompt. In some examples, training component 1050 computes a diffusion loss based on the ground-truth color map. Training component 1050 updates parameters of the text-to-mask generation model 1040 based on the diffusion loss.

In some examples, training component 1050 trains a mask-to-image generation model 1045 to generate a synthesized image based on a segmentation mask. In some examples, training component 1050 trains a segmentation model using the image segmentation mask. In some examples, training component 1050 initializes the text-to-mask generation model 1040 using parameters from a text-to-image generation model.

In some examples, diffusion models are based on a neural network architecture known as a U-Net. The U-Net takes input features having an initial resolution and an initial number of channels and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having the same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) ,$$

where p(x_{T})=N(x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood—log p_{θ}(x) of the training data. The training system then updates parameters of the model based on the comparison. For example, parameters of a U-Net may be updated using gradient descent. Time-dependent parameters of the Gaussian transitions can also be learned.

FIG. 11 shows an example of a machine learning model according to aspects of the present disclosure. The example shown includes text-to-mask generation model 1100 and mask-to-image generation model 1105.

In an embodiment, the data generation apparatus (see FIG. 10) includes two generative models, e.g., text-to-mask generation model 1100 and mask-to-image generation model 1105. One or more embodiments apply text-to-mask generation model 1100 and mask-to-image generation model 1105 to synthesize segmentation training samples. The process of generating segmentation training samples may be referred to as mask synthesis process and an image synthesis process based on setup and models used. In some examples, the mask synthesis involves generating synthesized (new) segmentation masks. Mask synthesis extracts the caption of a real image as a text prompt and uses the text prompt to generate new masks via text-to-mask generation model 1100. Then, the image segmentation masks and the text prompt are fed into mask-to-image generation model 1105 to produce the corresponding synthesized (new) images.

In some examples, image synthesis involves the synthesis of new images. Human-labeled masks and text prompts are input to mask-to-image generation model 1105 to generate synthesized images.

Text-to-mask generation model 1100 is an example of, or includes aspects of, the corresponding element described with reference to FIGS. 10, 12, and 13. Mask-to-image generation model 1105 is an example of, or includes aspects of, the corresponding element described with reference to FIGS. 10, and 12-14.

FIG. 12 shows an example of a machine learning model according to aspects of the present disclosure. The example shown includes text prompts 1200, text-to-mask generation model 1205, image segmentation masks 1210, mask-to-image generation model 1215, synthesized images 1220, synthetic training samples 1225, real segmentation masks 1230, additional synthesized images 1235, and additional synthetic training samples 1240.

In some embodiments, a machine learning model includes text-to-mask generation model 1205 and mask-to-image generation model 1215 to generate synthetic training data. The machine learning model performs a mask synthesis process and an image synthesis process. The synthetic training data can be used to train downstream segmentation models.

During the mask synthesis process (i.e., using text-to-mask generation model 1205), text prompts 1200 are input to text-to-mask generation model 1205 to generate image segmentation masks 1210. In some cases, image segmentation masks 1210 are also referred to as new segmentation masks. Then image segmentation masks 1210 are input to mask-to-image generation model 1215 to generate synthesized images 1220. Synthetic training samples 1225 include image segmentation masks 1210 and synthesized images 1220.

During the image synthesis process (i.e., exclusively using mask-to-image generation model 1215), real segmentation masks 1230 (e.g., human-labeled segmentation masks) are input to mask-to-image generation model 1215 to generate additional synthesized images 1235. Additional synthetic training samples 1240 include real segmentation masks 1230 and additional synthesized images 1235. The mask synthesis process and the image synthesis process each applies data generation ability of conditional generative models.

Text-to-mask generation model 1205 is an example of, or includes aspects of, the corresponding element described with reference to FIGS. 10, 11, and 13. Mask-to-image generation model 1215 is an example of, or includes aspects of, the corresponding element described with reference to FIGS. 10, 11, 13, and 14.

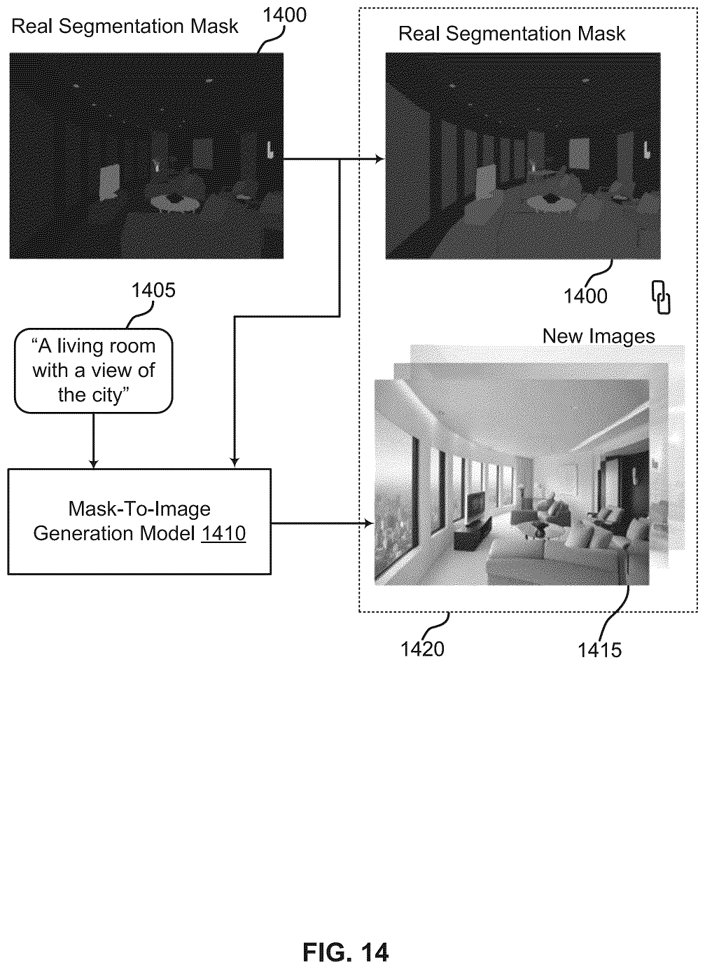

Image segmentation masks 1210 is an example of, or includes aspects of, the corresponding element described with reference to FIGS. 3 and 13. Synthesized images 1220 is an example of, or includes aspects of, the corresponding element described with reference to FIGS. 3-5, 13, and 14. Synthetic training samples 1225 is an example of, or includes aspects of, the corresponding element described with reference to FIGS. 13 and 14.

FIG. 13 shows an example of a text-to-mask generation model 1315 according to aspects of the present disclosure. The example shown includes real image 1300, captioner 1305, text prompt 1310, text-to-mask generation model 1315, image segmentation masks 1320, mask-to-image generation model 1325, synthesized images 1330, and synthetic training samples 1335.

In some embodiments, captioner 1305 extracts captions of real training images as text prompts from the target dataset. For example, captioner 1305 obtains text prompt 1310 by extracting it from real image 1300. Text prompt 1310 is “A living room with a view of the city”. The text prompts are used to condition the data generation process. Captioner 1305 is an example of, or includes aspects of, the corresponding element described with reference to FIG. 10.

To obtain image captions of existing training samples, captioner 1305 includes BLIP2-FlanT5ₓₓₗ model, which is a vision-language model. A prompt “Question: What are shown in the photo? Answer:” and an image are fed to the captioner 1305 to generate a response. Responses from the captioner 1305 serve as text prompts to condition the text-to-mask and mask-to-image generation process.

In an embodiment, conditional generative models include text-to-mask generation model 1315 and mask-to-image generation model 1325. The generative models comprise a diffusion model for image generation.

In an embodiment, text-to-mask generation model 1315 includes a diffusion model. [text, segmentation color map] training pairs are used to fine-tune a text-to-image diffusion-base model. These training pairs are from an image segmentation dataset (e.g. ADE20K). During sampling, text-to-mask generation model 1315 generates diverse color maps conditioned on text prompts (e.g., text prompt 1310). The color maps are converted into image segmentation masks 1320. In some examples, suppose an text prompt is T, the target height and width are H and W, the synthesized color map is C_{syn}∈ [symbol] ^{H×W×3}, and the synthesized segmentation map (with N masks) is M_{syn}∈ [symbol] ^{H×W×N}, the text-to-mask generation process is formulated as follows:

$${C}_{syn} = Text 2 Mask ( T ) \qquad ( 3 )$$

$${M}_{syn} = {f}_{color \to mask} ( {C}_{syn} ) \qquad ( 4 )$$

where f_{color→mask}: [symbol] ^{H×W×3}→ [symbol] ^{H×W×N} is the function that projects the color maps to segmentation masks.

The mask-to-image generation model 1325 is trained with [text, segmentation color map, image] triplets collected from the training splits of target datasets. In some examples, the input segmentation map is denoted as M∈ [symbol] ^{H×W×N}, the color map denoted as C∈ [symbol] ^{H×W×3}, the synthetic image denoted as I_{syn}∈ [symbol] ^{H×W×3}, and the mask-to-image generation process is formulated as follows:

$$C = {f}_{mask \to color} ( M ) \qquad ( 5 )$$

$${I}_{syn} = Mask 2 Img ( T , C ) \qquad ( 6 )$$

where f_{mask→color}: [symbol] ^{H×W×N}→ [symbol] ^{H×W×3} is the function to convert the segmentation masks: into a color map. The segmentation map M can be human-annotated or synthetic (i.e., M_{syn} from above Equation).

Referring to FIG. 13, image segmentation masks 1320 are input to mask-to-image generation model 1325 to generate synthesized images 1330. That is, a segmentation map M is a synthetic segmentation map (i.e., M_{syn} from above Equation). Human-annotated segmentation map M used for mask-to-image generation is described in greater detail in FIG. 14.

In an embodiment, a real training sample pair [image, segmentation masks] from a human-annotated segmentation dataset is obtained. Captioner 1305 is an image captioner model that extracts a caption of the real image 1300. The extracted caption serves as text prompt 1310 and is used to generate a set of diverse image segmentation masks 1320 using text-to-mask generation model 1315 following Eq. (3) and Eq. (4) above. Image segmentation masks 1320 and text prompt 1310 are fed into mask-to-image generation model 1325 to generate a synthesized image that aligns well with its segmentation mask. Accordingly, a synthetic training sample includes an image segmentation mask and a synthesized image. Synthetic training samples 1335 increase data diversity in segmentation masks for training models for image segmentation.

Real image 1300 is an example of, or includes aspects of, the corresponding element described with reference to FIG. 6. Text prompt 1310 is an example of, or includes aspects of, the corresponding element described with reference to FIGS. 3, 4, 14, and 15.

Text-to-mask generation model 1315 is an example of, or includes aspects of, the corresponding element described with reference to FIGS. 10-12. Mask-to-image generation model 1325 is an example of, or includes aspects of, the corresponding element described with reference to FIGS. 10-12, and 14.

In some examples, synthetic training samples 1335 include image segmentation masks 1320 and synthesized images 1330. Image segmentation masks 1320 is an example of, or includes aspects of, the corresponding element described with reference to FIGS. 3 and 12. Synthesized images 1330 is an example of, or includes aspects of, the corresponding element described with reference to FIGS. 3-5, 12, and 14. Synthetic training samples 1335 is an example of, or includes aspects of, the corresponding element described with reference to FIGS. 12 and 14.

FIG. 14 shows an example of a mask-to-image generation model 1410 according to aspects of the present disclosure. The example shown includes real segmentation mask 1400, text prompt 1405, mask-to-image generation model 1410, synthesized images 1415, and synthetic training samples 1420. Mask-to-image generation model 1410 is an example of, or includes aspects of, the corresponding element described with reference to FIGS. 10-13.

FIG. 14 illustrates an example of an image synthesis process, i.e., mask-to-image generation using real segmentation mask 1400. The image synthesis process involves increasing data diversity of images based on human-annotated segmentation masks. For each real training sample pair [image, segmentation mask], mask-to-image generation model 1410 takes a human-annotated segmentation mask and text prompt 1405 extracted from an image as input. In some cases, the human-annotated segmentation mask is also referred to as real segmentation mask 1400.

Mask-to-image generation model 1410 generates a set of synthesized images 1415 that align well with the human-annotated mask (i.e., real segmentation mask 1400). Synthetic training samples 1420 (new training samples) are generated. Synthetic training samples 1420 includes human-labeled segmentation masks and synthesized images 1415. Image synthesis is viewed as a type of data augmentation that improves data diversity on the image side. Example experiments indicate high alignment between synthesized images 1415 and their respective segmentation masks. The machine-generated synthesized images 1415 have shown improved mask-image alignment than real images. Human annotations tend to be imperfect due to difficulty of annotating segmentation masks.

Text prompt 1405 is an example of, or includes aspects of, the corresponding element described with reference to FIGS. 3, 4, 13, and 15. Synthesized images 1415 is an example of, or includes aspects of, the corresponding element described with reference to FIGS. 3-5, 12, and 13. Synthetic training samples 1420 is an example of, or includes aspects of, the corresponding element described with reference to FIGS. 12 and 13.

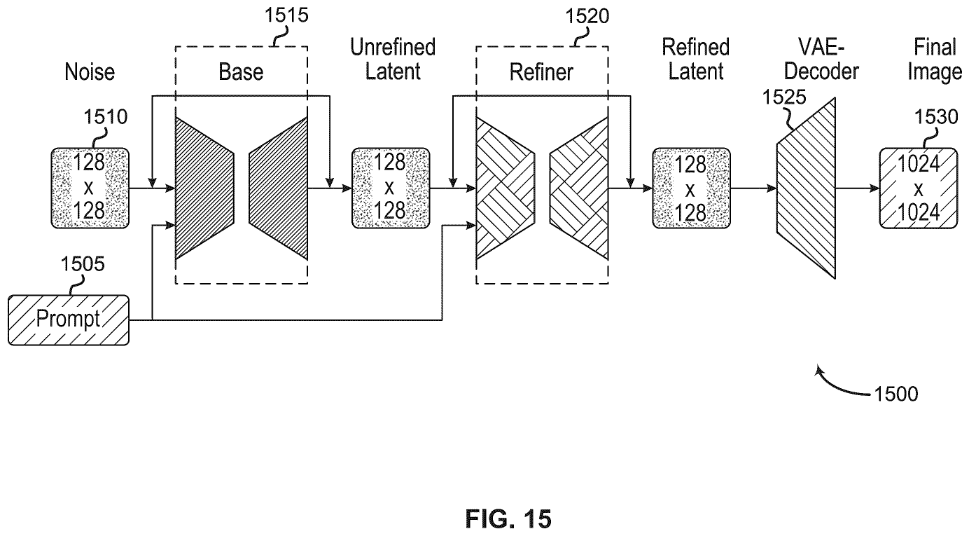

FIG. 15 shows an example of an image generation model 1500 according to aspects of the present disclosure. The example shown includes image generation model 1500, text prompt 1505, noise input 1510, diffusion model 1515, refiner network 1520, variational autoencoder (VAE) decoder 1525, and output image 1530. Text prompt 1505 is an example of, or includes aspects of, the corresponding element described with reference to FIGS. 3, 4, 13, and 14.

In an embodiment, text prompt 1505 and noise input 1510 are input to diffusion model 1515. The diffusion model 1515 generates initial latent code of size 128×128 by performing a denoising process. In some examples, a high-resolution refiner network 1520 takes the initial latent code as input and applies SDEdit on the latent code. Text prompt 1505 is fed to refiner network 1520. Refiner network 1520 generates refined latent code of size 128×128. Diffusion model 1515 and refiner network 1520 use a same autoencoder. The refined latent code is input to VAE decoder 1525 to obtain output image 1530 (i.e., a synthesized image). In some examples, the synthesized image is of size 1024×1024.

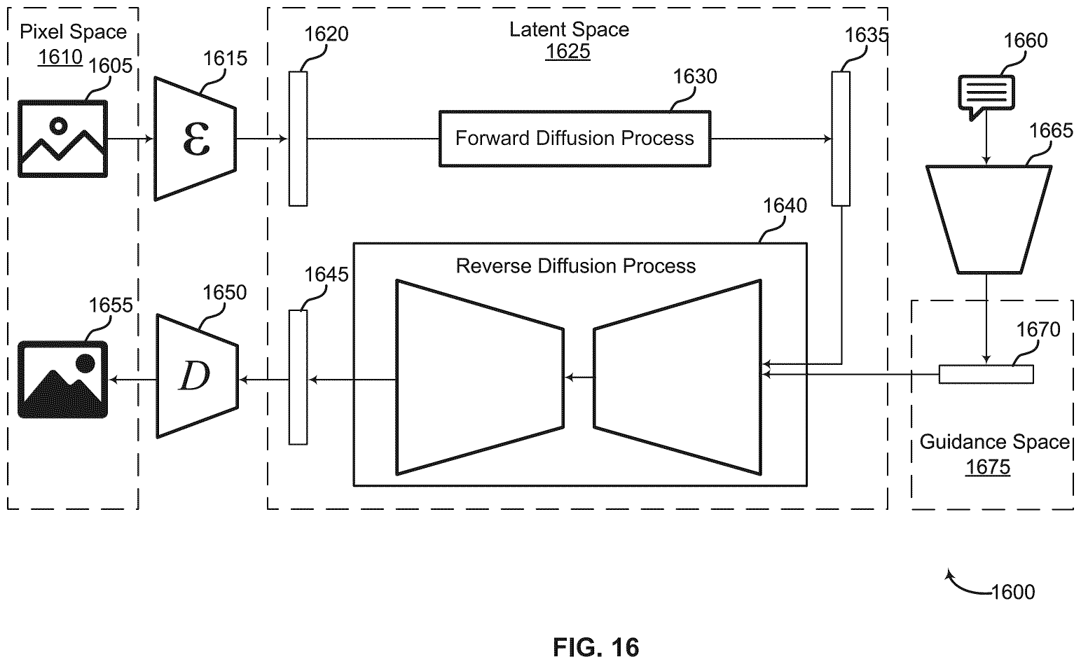

FIG. 16 shows an example of a guided latent diffusion model 1600 according to aspects of the present disclosure. The guided latent diffusion model 1600 depicted in FIG. 16 is an example of, or includes aspects of, the corresponding element described with reference to FIGS. 10 and 15.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1600 may take an original image 1605 in a pixel space 1610 as input and apply and image encoder 1615 to convert original image 1605 into original image features 1620 in a latent space 1625. Then, a forward diffusion process 830 gradually adds noise to the original image features 1620 to obtain noisy features 1635 (also in latent space 1625) at various noise levels.

Next, a reverse diffusion process 1640 (e.g., a U-Net ANN) gradually removes the noise from the noisy features 1635 at the various noise levels to obtain denoised image features 1645 in latent space 1625. In some examples, the denoised image features 1645 are compared to the original image features 1620 at each of the various noise levels, and parameters of the reverse diffusion process 1640 of the diffusion model are updated based on the comparison. Finally, an image decoder 1650 decodes the denoised image features 1645 to obtain an output image 1655 in pixel space 1610. In some cases, an output image 1655 is created at each of the various noise levels. The output image 1655 can be compared to the original image 1605 to train the reverse diffusion process 1640.

In some cases, image encoder 1615 and image decoder 1650 are pre-trained prior to training the reverse diffusion process 1640. In some examples, they are trained jointly, or the image encoder 1615 and image decoder 1650 and fine-tuned jointly with the reverse diffusion process 1640.

The reverse diffusion process 1640 can also be guided based on a text prompt 1660, or another guidance prompt, such as an image, a layout, a segmentation map, etc. The text prompt 1660 can be encoded using a text encoder 1665 (e.g., a multimodal encoder) to obtain guidance features 1670 in guidance space 1675. The guidance features 1670 can be combined with the noisy features 1635 at one or more layers of the reverse diffusion process 1640 to ensure that the output image 1655 includes content described by the text prompt 1660. For example, guidance features 1670 can be combined with the noisy features 1635 using a cross-attention block within the reverse diffusion process 1640.

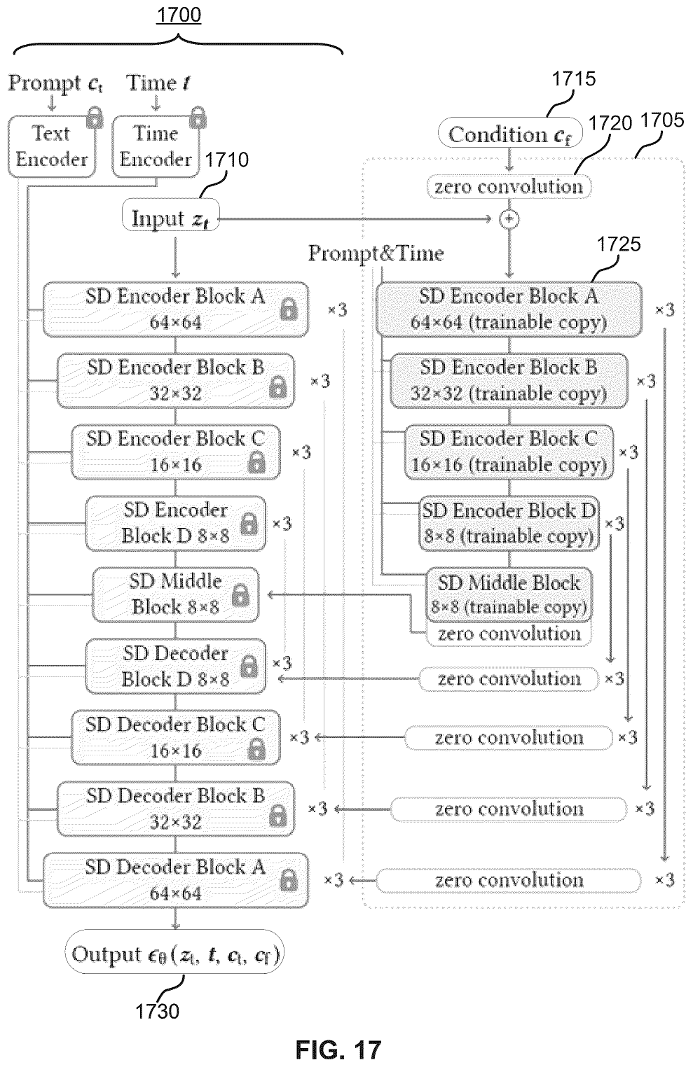

FIG. 17 shows an example of an image generation model comprising a control network according to aspects of the present disclosure. The example shown includes U-Net 1700, control network 1705, noisy image 1710, conditioning vector 1715, zero convolution layer 1720, trainable copy 1725, and learned network 1730.

ControlNet is a neural network structure configured to control image generation models by adding extra conditions. In some embodiments, a ControlNet architecture copies the weights from some of the neural network blocks of the image generation model to create a “locked” copy and a “trainable” copy 1725. The “trainable” one learns your condition. The “locked” copy preserves the parameters of the original model. The trainable copy 1725 can be tuned with a small dataset of image pairs, while preserving the locked copy ensures that original model is preserved.

As an example architecture shown in FIG. 17, the image generation model comprises U-Net 1700 (the left-hand side) and control network 1705 (the right-hand side). In some embodiments, a ControlNet architecture can be used to control a diffusion U-Net 1700 (i.e., to add controllable parameters or inputs that influence the output). Encoder layers of the U-Net 1700 can be copied and tuned. Then zero convolution layers can be added. The output of the control network 1705 can be input to decoder layers of the U-Net 1700.

In an embodiment, Stable Diffusion's U-Net is connected with a ControlNet on the encoder blocks and middle block. The locked blocks (light gray) show the structure of Stable Diffusion (U-Net architecture). The trainable copy blocks (dark gray) and the zero convolution layers are added to build a ControlNet. In some cases, trainable copy 1725 may be referred to as a trainable copy block or a trainable block.

In some embodiments, one or more zero convolution layers (e.g., 1720) are added to the trainable copy 1725. A “zero convolution” layer 1720 is 1×1 convolution with both weight and bias initialized as zeros. Before training, the zero convolution layers output all zeros. Accordingly, the ControlNet will not cause any distortion. As the training proceeds, the parameters of the zero convolution layers deviate from zero and the influence of the ControlNet on the output grows.

Given an input image z₀, image diffusion algorithms progressively add noise to the image and produce a noisy image zₜ, where t represents the number of times noise is added. Given a set of conditions including time step t, text prompts cₜ, as well as a task-specific condition c^{f}, image diffusion algorithms learn a network Ee to predict the noise added to the noisy image zₜ with:

$$L = {E}_{{z}_{0} , t , {c}_{t} , {c}_{f} , ϵ ∼ N ( 0 , 1 )} [ {‖ ϵ - ϵ ( {z}_{t} , t , {c}_{t} , {c}_{f} ) ‖}_{2}^{2} ] \qquad ( 7 )$$

where L is the overall learning objective of the entire diffusion model. This learning objective is directly used in fine-tuning diffusion models with ControlNet. The output from U-Net 1700 includes parameters corresponding to learned network 1730, e.g., output ϵ_{θ}(zₜ, t, cₜ, c_{f}).

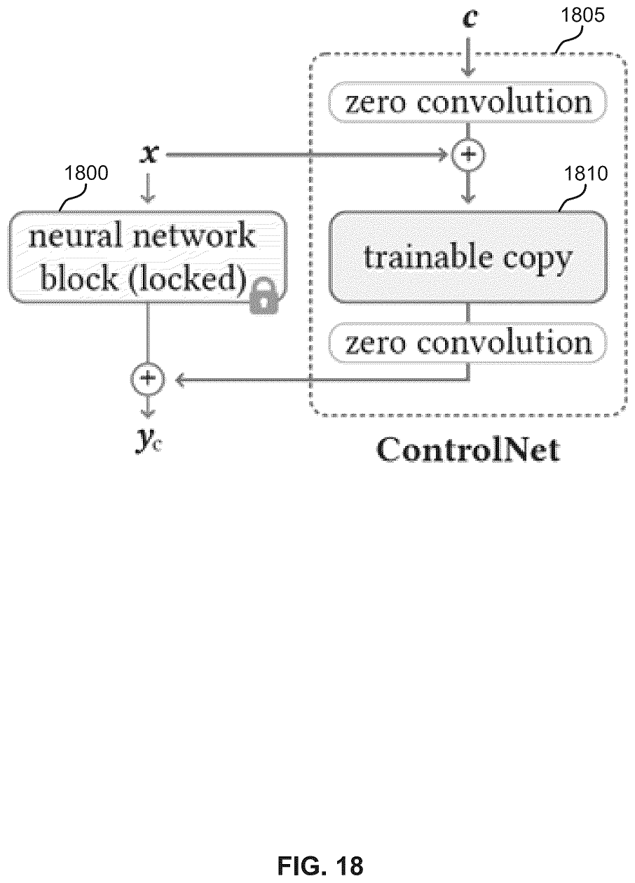

Control network 1705 is an example of, or includes aspects of, the corresponding element described with reference to FIGS. 10-11, and 15. Trainable copy 1725 is an example of, or includes aspects of, the corresponding element described with reference to FIG. 18.

FIG. 18 shows an example of a control network 1805 of an image generation model according to aspects of the present disclosure. The example shown includes neural network block 1800, control network 1805, and trainable copy 1810.

In some examples, a neural network block 1800 takes a feature map x as input and outputs another feature map y. To add a ControlNet (i.e., control network 1805) to such a block, some embodiments lock the original block and create a trainable copy 1810 and connect them together using zero convolution layers, i.e., 1×1 convolution with both weight and bias initialized to zero. Here c is a conditioning vector that is added to the network.

In an embodiment, Stable Diffusion's U-Net is connected with a ControlNet on the encoder blocks and middle block. The locked neural network block 1800 (light gray) shows a portion of the structure of Stable Diffusion (U-Net architecture). The trainable copy 1810 (dark gray) and the zero convolution layers are added to build a ControlNet. In some cases, trainable copy 1810 may be referred to as a trainable copy block or a trainable block.

Control network 1805 is an example of, or includes aspects of, the corresponding element described with reference to FIGS. 10-11, 15 and 17. Trainable copy 1810 is an example of, or includes aspects of, the corresponding element described with reference to FIG. 17.

In FIGS. 10-18, an apparatus and method for synthetic data generation are described. One or more embodiments of the apparatus and method include at least one processor; at least one memory including instructions executable by the at least one processor; and a text-to-mask generation model comprising parameters stored in the at least one memory and trained to generate a color map based on a text prompt, wherein the color map indicates a location of an object from the text prompt.

In some examples, the text-to-mask generation model is configured to generate an image segmentation mask for the object based on the color map. In some examples, the text-to-mask generation model comprises a diffusion model.

Some examples of the apparatus and method further include a mask-to-image generation model trained to generate a synthesized image based on the text prompt and an image segmentation mask. In some examples, the mask-to-image generation model comprises a diffusion model.

Some examples of the apparatus and method further include a text encoder configured to encode the text prompt to obtain text features representing the object, wherein the color map is generated based on the text features. Some examples of the apparatus and method further include a captioner configured to generate an image description based on an image.

### Training and Evaluation

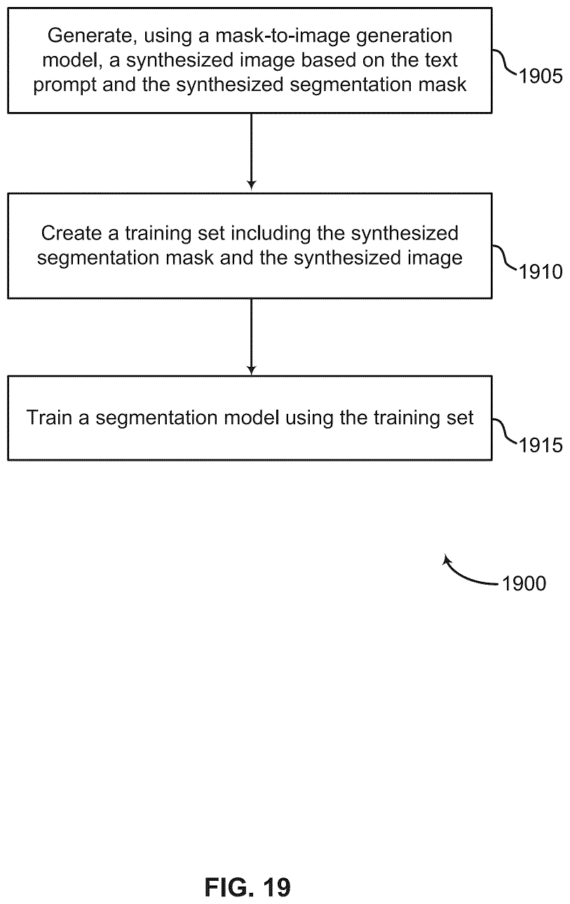

FIG. 19 shows an example of a method 1900 for creating a training set according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1905, the system generates, using a mask-to-image generation model, a synthesized image based on the text prompt and the image segmentation mask. In some cases, the operations of this step refer to, or may be performed by, a mask-to-image generation model as described with reference to FIGS. 10-14.

In an embodiment, a text-to-mask generation model and a mask-to-image generation model synthesize new mask-image pairs. This way, the diversity in segmentation masks is increased (e.g., can be used for model supervision). In some examples, the mask-to-image generation model synthesizes new images based on pre-existing masks, increasing image diversity for model inputs.

At operation 1910, the system creates a training set including the image segmentation mask and the synthesized image. In some cases, the operations of this step refer to, or may be performed by, a training component as described with reference to FIG. 10. In some cases, creating a training set can include obtaining a pre-existing set of training data for training a machine learning model (e.g., a segmentation model).

In an embodiment, the created training set is used to train a machine learning model for image segmentation. A text-to-mask generation model, a mask-to-image generation model, or both generation models are used to create the training set.

At operation 1915, the system trains a segmentation model using the training set. In some cases, the operations of this step refer to, or may be performed by, a training component as described with reference to FIG. 10.

In some examples, the segmentation model is initialized using random values. In other examples, the segmentation model is initialized based on a pre-trained model.

On the competitive ADE20K and COCO benchmarks, apparatus, system, and data generation methods of the present disclosure improves performance of segmentation models in semantic segmentation, panoptic segmentation, and instance segmentation. Notably, in terms of the ADE20K mIoU, ask2Former R50 is largely boosted from 47.2 to 49.9 (+2.7); Mask2Former Swin-L is also significantly increased from 56.1 to 57.4 (+1.3). The example experiments and their results indicate the effectiveness of apparatus, system, and data generation methods of the present disclosure. Additionally, training with synthetic data makes the segmentation models more robust towards unseen domains. In some cases, human-annotated training data is used to train the segmentation models.

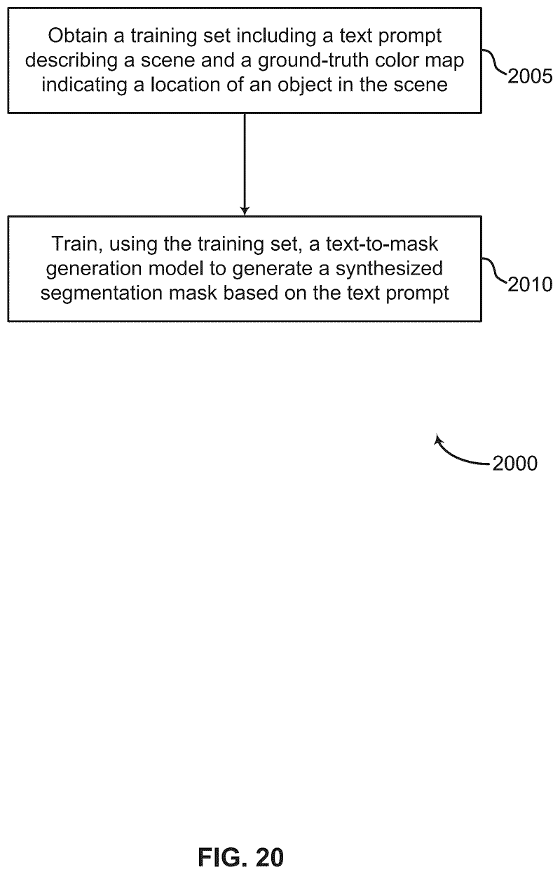

FIG. 20 shows an example of a method 2000 for training a text-to-mask generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 2005, the system obtains a training set including a text prompt describing a scene and a ground-truth color map indicating the location of an object in the scene. In some cases, the operations of this step refer to, or may be performed by, a training component as described with reference to FIG. 10.

In some examples, a conditional generative model (e.g., a diffusion-based model) is initialized using random values. In other examples, the conditional generative model is initialized based on a pre-trained model. In some examples, the conditional generative model includes base parameters from a pre-trained model.

At operation 2010, the system trains, using the training set, a text-to-mask generation model to generate an image segmentation mask based on the text prompt. In some cases, the operations of this step refer to, or may be performed by, a training component as described with reference to FIG. 10.

In some embodiments, a text-to-mask generation model is trained to generate diverse image segmentation masks based on text prompts. To leverage the generation capacity of text-to-image generation models pre-trained on large-scale datasets, some embodiments, at training, encode the segmentation masks (the pixel values are category IDs) as three-channel RGB-like color maps, where one color represents a certain category.

In some cases, based on experiments, a color map reconstructed by VAE (e.g., SDXL model) is almost indistinguishable from the original input. In some examples, the training component is configured to fine-tune a text-to-image generation model (e.g., SDXL-base model) with [text, segmentation color map] training pairs. These training pairs are from an image segmentation dataset (e.g., ADE20K). During sampling, the text-to-mask generation model can generate diverse color maps conditioned on text prompts. The color maps are converted into image segmentation masks.

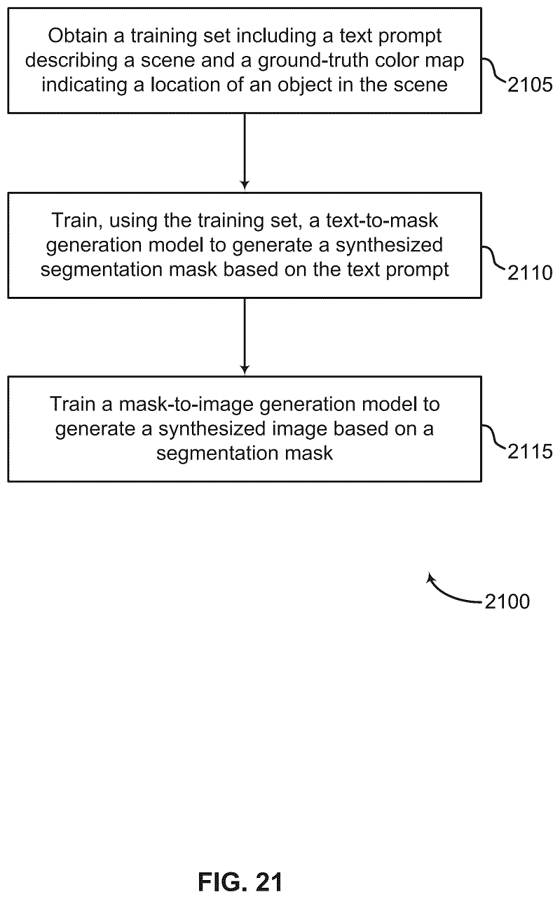

FIG. 21 shows an example of a method 2100 for training a mask-to-image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 2105, the system obtains a training set including a text prompt describing a scene and a ground-truth color map indicating a location of an object in the scene. In some cases, the operations of this step refer to, or may be performed by, a training component as described with reference to FIG. 10.

In some examples, a conditional generative model (e.g., a diffusion-based model) is initialized using random values. In other examples, the conditional generative model is initialized based on a pre-trained model. In some examples, the conditional generative model includes base parameters from a pre-trained model.

At operation 2110, the system trains, using the training set, a text-to-mask generation model to generate an image segmentation mask based on the text prompt. In some cases, the operations of this step refer to, or may be performed by, a training component as described with reference to FIG. 10.

At operation 2115, the system trains a mask-to-image generation model to generate a synthesized image based on a segmentation mask. In some cases, the operations of this step refer to, or may be performed by, a training component as described with reference to FIG. 10.

In some embodiments, the mask-to-image generation model is trained to synthesize new images that align well with the given segmentation masks and text prompts. In some examples, the mask-to-image generation model includes a control network (e.g., Control-Net). The pre-trained weights of a diffusion model (e.g., SDXL-base model) are frozen and an additional network for mask-conditioned image generation is trained. The mask-to-image generation model simultaneously maintains the generalization ability of the pre-trained diffusion model while performing controllable generation. In some examples, the mask-to-image generation model is trained with [text, segmentation color map, image] triplets collected from the training splits of the target datasets.

In FIGS. 19-21, a method, apparatus, and non-transitory computer readable medium for synthetic data generation are described. One or more embodiments of the method, apparatus, and non-transitory computer readable medium include obtaining a training set including a text prompt describing a scene and a ground-truth color map indicating a location of an object in the scene and training, using the training set, a text-to-mask generation model to generate an image segmentation mask based on the text prompt.

Some examples of the method, apparatus, and non-transitory computer readable medium further include computing a diffusion loss based on the ground-truth color map. Some examples further include updating parameters of the text-to-mask generation model based on the diffusion loss.

Some examples of the method, apparatus, and non-transitory computer readable medium further include training a mask-to-image generation model to generate a synthesized image based on a segmentation mask.

Some examples of the method, apparatus, and non-transitory computer readable medium further include training a segmentation model using the image segmentation mask.

Some examples of the method, apparatus, and non-transitory computer readable medium further include obtaining an image corresponding to the ground-truth color map. Some examples further include generating the text prompt based on the image.

Some examples of the method, apparatus, and non-transitory computer readable medium further include initializing the text-to-mask generation model using parameters from a text-to-image generation model.

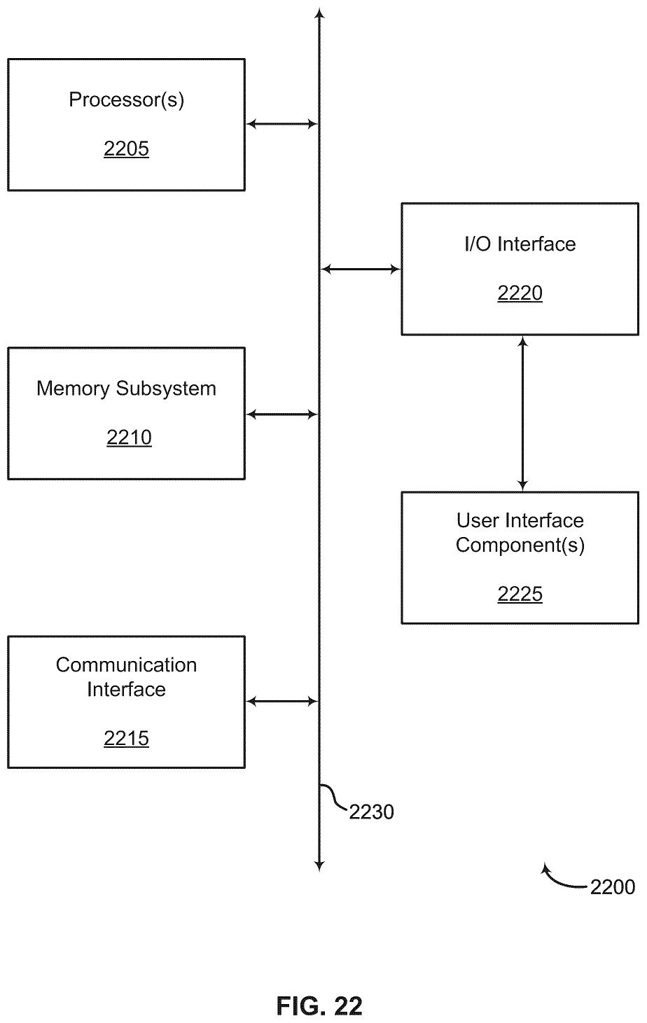

FIG. 22 shows an example of a computing device 2200 for data generation according to aspects of the present disclosure. The example shown includes computing device 2200, processor(s) 2205, memory subsystem 2210, communication interface 2215, I/O interface 2220, user interface component(s) 2225, and channel 2230. In one embodiment, computing device 2200 includes processor(s) 2205, memory subsystem 2210, communication interface 2215, I/O interface 2220, user interface component(s) 2225, and channel 2230.

In some embodiments, computing device 2200 is an example of, or includes aspects of, data generation apparatus 110 of FIG. 1. In some embodiments, computing device 2200 includes one or more processors 2205 that can execute instructions stored in memory subsystem 2210 to obtain a text prompt describing an object; generate, using a text-to-mask generation model, a color map that indicates an image region occupied by the object with a color corresponding to the object; and generate an image segmentation mask for the object based on the color map.

According to some embodiments, computing device 2200 includes one or more processors 2205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some embodiments, memory subsystem 2210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some embodiments, communication interface 2215 operates at a boundary between communicating entities (such as computing device 2200, one or more user devices, a cloud, and one or more databases) and channel 2230 and can record and process communications. In some cases, communication interface 2215 is provided to enable a processing system coupled to a transceiver (e.g., a transmitter and/or a receiver). In some examples, the transceiver is configured to transmit (or send) and receive signals for a communications device via an antenna.

According to some embodiments, I/O interface 2220 is controlled by an I/O controller to manage input and output signals for computing device 2200. In some cases, I/O interface 2220 manages peripherals not integrated into computing device 2200. In some cases, I/O interface 2220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2220 or via hardware components controlled by the I/O controller.

According to some embodiments, user interface component(s) 2225 enables a user to interact with computing device 2200. In some cases, user interface component(s) 2225 include an audio device, such as an external speaker system, an external display device such as a display screen, an input device (e.g., a remote-control device interfaced with a user interface directly or through the I/O controller), or a combination thereof. In some cases, user interface component(s) 2225 includes a GUI.

Performance of apparatus, systems and methods of the present disclosure have been evaluated, and results indicate embodiments of the present disclosure have obtained increased performance over existing technology. Example experiments demonstrate that the data generation apparatus described in embodiments of the present disclosure outperforms conventional systems.

To evaluate the effectiveness of the data generation methods in improving segmentation performance, some examples include mainstream segmentation models and commonly used evaluation benchmarks for several segmentation tasks. The experiments are conducted mostly under fully-supervised learning setting, meaning all human-annotated training samples from the evaluated datasets are used alongside the synthetic data.

With regard to segmentation datasets and evaluation, experiments have been conducted on three image segmentation benchmarks following the experimental settings of Mask2Former: ADE20K semantic segmentation, COCO panoptic segmentation, and COCO instance segmentation. The evaluation uses all 150 classes for ADE20K and 133 classes for COCO. For semantic segmentation, the mean Intersection-over-Union metric (mIoU) is recorded.

For instance segmentation, the average precision (AP) is used. For panoptic segmentation, panoptic quality (PQ), “thing” instance segmentation APpun, and semantic segmentation mloUpan are recorded.

In some examples, Mask2Former (a transformer model) is used as the default segmentation model for testing and evaluation. Two typical backbones, i.e., R50 and Swin-L are studied. The implementation and training hyper-parameters of the segmentation models are kept unchanged. Some examples includes conducting experiments on Mask DINO (a detection-aided segmentation model) and HRNet W48 (a representative fully-convolutional model).

During data sampling, for each training sample in the ADE20K semantic segmentation dataset, text-to-mask generation model 1040 (with reference to FIG. 10) generates 10 synthetic mask-image pairs using a mask synthesis process described in FIG. 12, resulting in 202,100 training samples. Additionally, mask-to-image generation model 1045 generates 50 images based on each human-labeled mask via an image synthesis process described in FIG. 12, leading to a total of 1,010,500 samples. When it comes to COCO instance and panoptic segmentation, obtaining instance information from color maps is challenging. Hence, the models rely on the image synthesis process for COCO data synthesis. By generating 10 synthetic images conditioned on each human-labeled panoptic segmentation mask via the image synthesis process, the synthetic dataset amounts to 1,182,870 synthetic samples, which can be used to train panoptic and instance segmentation models.

As for ADE20K Semantic Segmentation, some examples include using the synthetic data augmentation strategy with p_{aug}=60% for Mask2Former model. Data generation apparatus 1000 with reference to FIG. 10 improves the mIoU of Mask2Former R50 by +2.7 for single-scale inference and +2.2 for multi-scale inference, achieving 49.9 and 51.4 correspondingly. The Swin-L model is improved from 56.1/57.3 (singles-cale/multi-scale) to 57.4/58.7 (+1.3/+1.4). Embodiments of the present disclosure help Mask2Former model surpass models such as Mask DINO and OneFormer, while establishing new benchmark results for R50 and Swin-L settings without using additional human-annotated data.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text prompt describing an object within a scene;
generating, using a text-to-mask generation model and based on the text prompt, a color map corresponding to the scene, wherein the color map indicates a region corresponding to the object from the text prompt; and
generating an image segmentation mask based on the color map, wherein the image segmentation mask comprises a plurality of regions corresponding to a plurality of image elements in the scene including the region corresponding to the object from the text prompt.

2. The method of claim 1, further comprising:
generating, using a mask-to-image generation model, a synthesized image based on the text prompt and the image segmentation mask.

3. The method of claim 2, further comprising:
creating a training set including the image segmentation mask and the synthesized image; and
training a segmentation model using the training set.

4. The method of claim 1, further comprising:
obtaining an annotated segmentation mask; and
generating, using a mask-to-image generation model, a synthesized image based on the text prompt and the annotated segmentation mask.

5. The method of claim 1, further comprising:
generating a plurality of image segmentation masks based on the color map.

6. The method of claim 1, further comprising:
encoding the text prompt to obtain text features representing the object, wherein the color map is generated based on the text features.

7. The method of claim 1, wherein:
the color map includes a plurality of colors corresponding to a plurality of elements of the scene described by the text prompt.

8. A method of training a machine learning model, the method comprising:
obtaining a training set including a text prompt describing a scene and a ground-truth color map indicating a region corresponding to an object in the scene; and
training, using the training set, a text-to-mask generation model to generate an image segmentation mask based on the text prompt.

9. The method of claim 8, wherein training the text-to-mask generation model comprises:
computing a diffusion loss based on the ground-truth color map; and
updating parameters of the text-to-mask generation model based on the diffusion loss.

10. The method of claim 8, further comprising:
training a mask-to-image generation model to generate a synthesized image based on a segmentation mask.

11. The method of claim 8, further comprising:
training a segmentation model using the image segmentation mask.

12. The method of claim 8, wherein obtaining the training set comprises:
obtaining an image corresponding to the ground-truth color map; and
generating the text prompt based on the image.

13. The method of claim 8, further comprising:
initializing the text-to-mask generation model using parameters from a text-to-image generation model.

14. An apparatus comprising:
at least one processor;
at least one memory including instructions executable by the at least one processor; and
a text-to-mask generation model comprising parameters stored in the at least one memory and trained to generate a color map based on a text prompt, wherein the color map indicates a region corresponding to an object from the text prompt.

15. The apparatus of claim 14, wherein:
the text-to-mask generation model is configured to generate an image segmentation mask for the object based on the color map.

16. The apparatus of claim 14, wherein:
the text-to-mask generation model comprises a diffusion model.

17. The apparatus of claim 14, further comprising:
a mask-to-image generation model trained to generate a synthesized image based on the text prompt and an image segmentation mask.

18. The apparatus of claim 17, wherein:
the mask-to-image generation model comprises a diffusion model.

19. The apparatus of claim 14, further comprising:
a text encoder configured to encode the text prompt to obtain text features representing the object, wherein the color map is generated based on the text features.

20. The apparatus of claim 14, further comprising:
a captioner configured to generate an image description based on an image.
